(19) United States
(12) Patent Application Publication
(10) Pub. No.: US 2003/0138594 A1
(43) Pub. Date: Jul. 24, 2003

(54) Non-woven shaped fiber media loaded with expanded polymer microspheres

(75) Inventors: Alex Lobovsky, New Providence, NJ (US); James A. Matrunich, Mountainside, NJ (US); Al MacKnight, Lakewood, CA (US)

Correspondence Address: Honeywell International, Inc., Law Dept. AB2, P.O. Box 2245, Morristown, NJ, 07962-9806, US

(73) Assignee: Honeywell International, Inc., Law Dept., Morristown, NJ (US)

(21) Appl. No.: 10/052,746

(22) Filed: Jan. 18, 2002

(51) Int. Cl. B32B 3/02; D04H 1/00; D04H 5/00; B32B 5/16; B32B 9/00; B32B 9/02

(52) U.S. Cl. 428/91; 428/85; 428/402.2

(57) ABSTRACT

An insulating composite material comprising expanded microcells and fiber media and methods for producing same. Microcells incorporated into the fiber media engage the surface projections and the intra-fiber and inter-fiber voids, resulting in increased microcell retention, thereby improving the characteristics of the composite material.

### BACKGROUND OF THE INVENTION

The present invention generally relates to composite materials incorporating microcells as well as processes for preparing the same. More specifically, this invention relates to insulating composite materials comprising fiber media and expanded polymer microcells.

Expandable and non-expandable microspheres have been used extensively in many fields and may be the most commonly used microcells, but other shapes have been described. Expandable microtubes have been disclosed. These microtubes may have cross-sections of various geometries including circular, oval, star-shaped, and triangular. It is also thought possible for expandable microcell shapes to include ellipsoids and cubes.

It is known in the art that the incorporation of microcells in a material may have desirable effects. The absorbing capacity for liquid curable resins has been adjusted by embedding microspheres in reinforcing materials for duroplastics. Density and weight have been reduced in syntactic foam core materials by intermixing microspheres with dry resin powders. Resiliency and shock-absorbency have been enhanced in polyurethane foam bodies by implanting microspheres into the open cells of the bodies. Microspheres have been used to enhance the sensitivity of explosives and to increase stiffness and bulk in paper and board. Additionally, they have been used in printing inks to create 3-D patterns on sportswear and wallpaper. It is also recognized that many properties of insulating fiber media may be improved by incorporating microcells into these materials.

Those in the field have recognized the advantages of incorporating microcells into fiber media. These advantages may include decreased density and weight, improved resilience to deformation, increased loft, and improved insulating properties. Methods for incorporating microcells into fiber media have been disclosed.

Many of the described methods for incorporating expandable microcells into fiber media include the addition of an adhesive or a binder. Unfortunately, the addition of an adhering material has been found to have disadvantages. The disadvantages described include increased weight and density, decreased insulating properties, reduced recoverability, increased stiffness, and increased air displacement.

Another method for incorporating expandable microcells into fiber media has been described in U.S. Pat. No. 4,820,575. In this invention, a reinforcing material for duroplastics having reduced resin pick-up is disclosed. A yarn or roving is drawn through an aqueous suspension containing the microspheres. Ultrasonic vibrations are used to spread apart the elementary fibers of the yarn and the microspheres enter the voids between the elementary fibers. The yarn is then dried and the microspheres are expanded. Reinforcing materials produced by this method have reduced resin pick-up because the microspheres now occupy a portion of the inter-fiber void that would otherwise be filled with resin. Although this method does not require the addition of adhesives or binders, improved methods are needed to further increase microsphere retention.

Other methods for adding microspheres to a fiber media are disclosed in U.S. Pat. No. 5,571,592. In one disclosed method, the use of a blowing apparatus to deposit microspheres, microfibers and crimped fibers onto a substrate is described. Unfortunately, many desirable insulating fibers may not be useful in this method, as it is limited to microfibers. Additionally, materials produced according to this method may have unsatisfactory resiliency and loft.

In another disclosed method, the microspheres are motivated into the fiber media. In the preferred method, a barrier layer, described as having a pore structure large enough to allow unexpanded microspheres to pass through but small enough to resist the passage of expanded microspheres, is first sewn to the fiber media. Unexpanded microspheres are motivated through the barrier layer and into the fiber media where they are then expanded. Unfortunately, the microspheres are not adequately retained within the fiber media as they are held within the finished product by the barrier layer. Methods to assist in holding the microspheres in the fiber media are also described. Stitching in a quilted-fashion to form smaller barrier layer defined spaces is one disclosed method for reducing the migration and conglomeration of the expanded microspheres. Two other methods described are heating to adhere the microspheres to the surrounding insulation material and adding an adhesive to the microspheres and/or the fibers. By using these methods disclosed in U.S. Pat. No. 5,571,592 it is possible to produce a composite material comprising microspheres and fiber media; however, improved methods for retaining the microspheres within the fiber media are still needed.

As can be seen, there is a need for improved composite materials comprising microcells and fiber media, and methods for their production. Specifically, an improved insulating composite material comprising a fiber media and microcells is needed, wherein microcell retention within the fiber media is increased and desirable properties of the composite material are improved. Also needed are methods for incorporating microcells into a fiber media without reducing the resiliency of the media, increasing the weight and density of the media, decreasing the insulating properties of the media, reducing the recoverability of the media, or increasing the stiffness of the media.

### SUMMARY OF THE INVENTION

In one aspect of the present invention, a composite material comprises a fiber media, wherein the fiber media comprises at least one fiber having at least one surface projection, whereby at least one intra-fiber void is formed; and at least one microcell in contact with the fiber media, wherein the microcell is engaged by the intra-fiber void.

In another aspect of the present invention, a method for producing a composite material comprises the steps of providing a fiber media, the fiber media comprises at least one fiber having at least one surface projection, whereby at least one intra-fiber void is formed; and incorporating at least one microcell into the fiber media, wherein the microcell is engaged by the intra-fiber void.

These and other features, aspects and advantages of the present invention will become better understood with reference to the following drawings, description and claims.

### BRIEF DESCRIPTION OF THE DRAWINGS

FIG. 1 is a microscopic photograph of a composite material according to an embodiment of the present invention;

FIG. 2a is a schematic cross-section of a composite material according to an embodiment of the present invention;

FIG. 2b is a schematic cross-section of a composite material according to another embodiment of the present invention.

### DETAILED DESCRIPTION OF THE INVENTION

The present invention generally provides composite materials comprising fiber media and microcells and methods for producing the same. The composite materials produced according to the present invention may find beneficial use in many industries including aerospace, automotive, acoustic and thermal building insulations, environmental control system, fuel cell system, home appliance, reinforcing materials, textiles and apparel. Yarns, roving, woven and non-woven articles comprising the composite material of the present invention may be useful. Additionally, the materials of this invention may be useful as insulating material in low-pressure atmospheres. For this application, the microcells may be expandable microcells. After expansion, the expandable microcells may comprise a vacuum and a blowing agent condensate core enclosed in a polymer shell. Materials comprising microcells with enclosed vacuums may be desirable as insulation in the aerospace industry.

The composite materials of this invention can comprise microcells incorporated into a media comprising fibers. The fibers may have surface projections such as continuously longitudinal lobes. These surface projections may increase the surface area of the fibers and form intra-fiber voids. The intra-fiber voids are defined as the voids between and within the surface projections of the fibers. Microcells incorporated into the fiber media may engage the intra-fiber voids by passing into the intra-fiber voids and being retained therein. This engagement by the microcell may increase microcell retention within the fiber media by improving contact between the microcells and the fibers. Microcell retention increased by microcell engagement of the intra-fiber voids of the fiber is unlike the prior art. The present invention may increase microcell retention without the disadvantages described in the prior art, such as increasing weight and density, decreasing insulating properties, reducing recoverability and increasing stiffness.

In one embodiment of the present invention, unexpanded microcells may be incorporated into a lobed polymer fiber media. The unexpanded microcells may be capable of entering the intra-fiber voids. The unexpanded microcells may enter the intra-fiber voids during spin-draw fiber manufacturing process or during the following rewinding of the fiber yarn. The fiber may be run through an enclosure where the unexpanded microcells are continuously air-jet injected on the surface of the fiber. The fiber may be electrostatically charged to facilitate entrapment of microcells. After being incorporated into the fiber media, the microcells may be expanded. This may be achieved by heating the microcells entrapped in the yarn to temperatures between about 75 C. and about 190 C. This process may be continuous by means of running the yarn through a heated oven. The volume of the fully expanded microcells may be more than 40 times the volume of the unexpanded microcells. The dramatic expansion of the microcells may be due to the fact that a blowing agent, such as a small amount of liquid hydrocarbon, may be encapsulated within a gastight thermoplastic shell. Microcell retention may be provided by both the intra-fiber voids and the inter-fiber voids. Inter-fiber voids are defined as the voids between fibers. The more entangling environment of the fiber media may provide an increase in microcell retention. Migration and conglomeration of expanded microspheres may be decreased without the addition of barrier layers or adhesives.

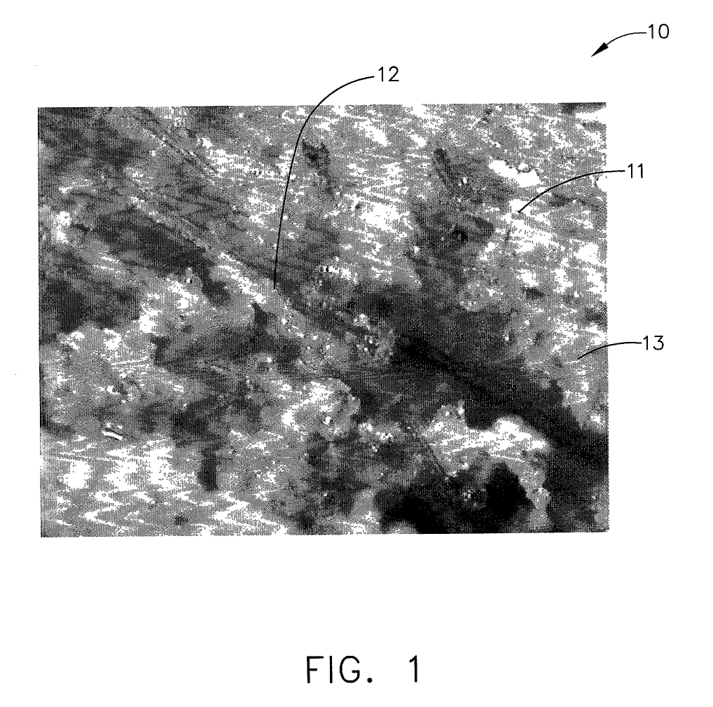

In FIG. 1, a microscopic photograph of a composite material 10 made according to an embodiment of the present invention is depicted. The fibers 11 may have surface projections 12, wherein the surface projections may be continuously longitudinal lobes capable of engaging the microcells 13.

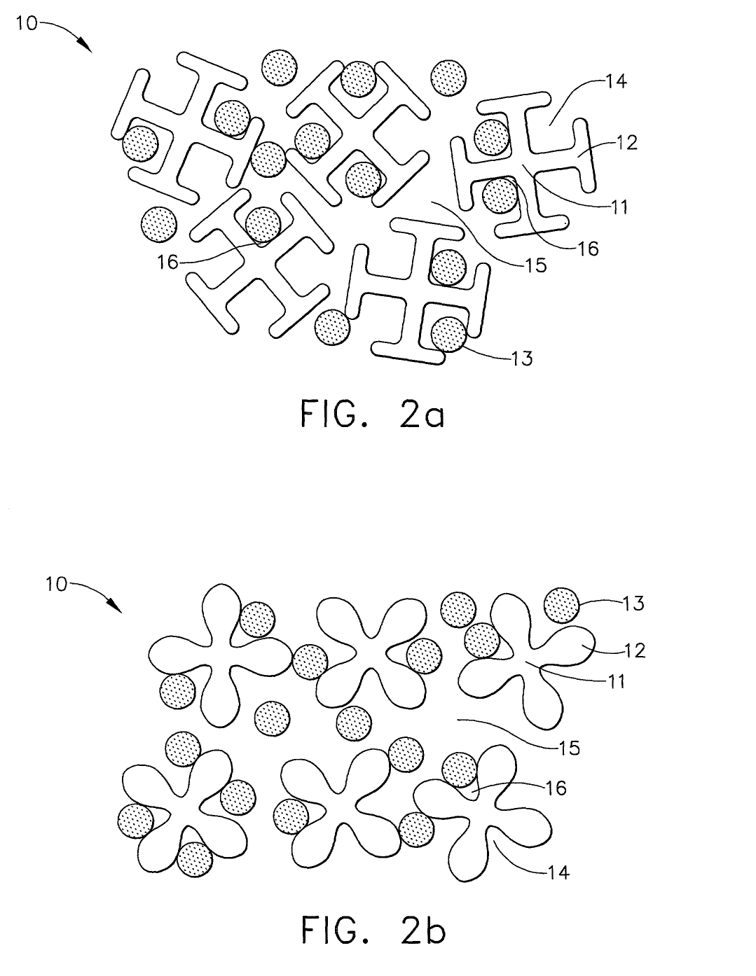

As better seen in FIGS. 2a and 2b, the composite material 10 can contain intra-fiber voids 14 and inter-fiber voids 15 capable of engaging the microcells 13. The microcells 13 may not only occupy the inter-fiber voids 15, but they may also occupy the intra-fiber voids 14 (not shown). In FIG. 2a, the fibers 11 have four surface projections 12 that are T-shaped lobes for purposes of example. In FIG. 2b, the fibers 11 have four surface projections 12 that are oval-shaped lobes for purposes of example. However, the present invention contemplates other shaped lobes and other numbers of lobes. Furthermore, the shaped lobes can be different from fiber to fiber, as well as the number of lobes.

As can be seen in FIGS. 2a and 2b, the present invention can increase microcell 13 retention by increasing the contact between the fibers 11 and the microcells 13. In the present invention, increased microcell retention may be achieved by the contact between the microcells 13 and the fibers 11 without the addition of an adhesive. The fibers 11 may have surface projections 12 that increase the surface area of the fibers, whereby microcell contact with the fibers is increased because the surface area of the fibers is increased. In one embodiment of the present invention, polymer microcells may adhere to the polymer fibers during microcell expansion, whereby microcell retention is proportional to microcell/fiber contact.

Additionally, intra-fiber voids 14 may increase microcell retention. In one embodiment of the present invention, unexpanded microcells may enter the intra-fiber voids. After the microcells are expanded, they may become entrapped within the intra-fiber voids, thus increasing the microcells retained within the fiber media. The microcells may become entrapped within the intra-fiber voids because the microcells may be capable of passing into and out of the intra-fiber voids while in an unexpanded form and inhibited from passing into and out of the intra-fiber voids while in an expanded form. This inhibition may be due to the surface projections. For example, adjacent T-shaped lobes, each having a leg and a cap, may define an intra-fiber void having a diameter larger than the distance between the adjacent caps. An unexpanded microcell, having a diameter smaller than the distance between the adjacent caps, may enter the intra-fiber void. The microcell may then be expanded to a diameter larger than the distance between the adjacent caps, whereby the microcell may be inhibited from passing out of the intra-fiber void by the adjacent caps. Further, increased microcell retention may increase the volume of the air pockets 16 within the composite material 10. The air pockets are the areas within the fiber media enclosed by the microcell shells and/or the fiber surfaces. The number of air pockets may be increased because the number of microcells retained within the fiber media may be increased. The increased volume of air pockets increases the thermal insulating properties of the material because air pockets are known to be thermally insulating.

Further, the composite material 10 may also have improved acoustic insulating properties. The sound absorbance characteristic of a fiber material is known to be a function of the acoustic impedance of the material. The acoustic impedance is known to consist of the frequency dependent components of acoustic reactance and acoustic resistance. Acoustic reactance is known to depend on the thickness of the material and acoustic resistance is known to depend on the airflow resistance of the material. Increasing the surface area of the fibers and/or increasing microcell retention within the material may increase the airflow resistance. The increased airflow resistance increases the acoustic resistance and therefore the acoustic impedance, whereby the acoustic insulating property of the material is improved.

Fiber media useful in this invention may comprise fibers 11 having increased surface areas, surface projections or intra-fiber voids. Polymer, mineral or a combination of polymer and mineral fibers may be useful in the present invention. Polymer fibers having surface projections are described in U.S. Pat. No. 5,057,368 and mineral fibers having surface projections are described in U.S. Pat. No. 4,636,234, both of which are herein incorporated by reference. Other useful fibers may include, but are not limited to, bicomponent polymer fibers described in U.S. Pat. Nos. 4,439,487 and 3,092,892 and multilobal polymer fibers described in U.S. Pat. Nos. 4,648,830 and 4,770,938, all of which are incorporated herein by reference. Fibers 11 useful in this invention may have a modification ratio of at least about 2 and a shape factor of at least about 1.5. In other embodiments of the present invention, the modification ratio of the fiber can be between about 2 and about 10, and the shape factor can be between about 1.5 and about 6. In still further embodiments of the present invention the modification ratio of the fiber can be between about 3 and about 7, and the shape factor can be between about 2 and about 4. The modification ratio of a fiber is defined as the outer diameter of a fiber divided by the inner diameter of that fiber. The outer diameter is the diameter of the smallest circle into which the entire cross-section of the fiber can be placed. The inner diameter of a fiber is the diameter of the largest circle that can be positioned within the cross-section of the fiber. The second parameter describing the degree of the fiber surface modification is the shape factor. Shape factor is defined as the ratio of perimeter to cross-sectional area of a fiber divided by the ratio of perimeter to cross-sectional area of the perfectly round fiber.

Some of the fibers of the present invention may be produced according to U.S. Pat. No. 5,057,368. These multilobal polymer fibers may have continuously longitudinal intra-fiber voids. The cross-sections of useful fibers may include a central core having at least one lobe projecting therefrom. The lobes may have various shapes including oval, T-shaped and crescent. Preferred fibers may have intra-fiber voids capable of engaging the microcells and assisting in microcell retention. These intra-fiber voids may be large enough to receive the unexpanded but expandable microcell. Fiber media of a preferred embodiment may have an increased surface area and more than one surface projection that may assist in trapping and retaining the incorporated microcells. Preferred polymer fibers may be formed from a nylon, a polyester, a polyolefin or a combination thereof. More preferred fibers may be formed from polyester, polypropylene, or nylon 6 with FAV (Formic Acid Viscosity) of at least about 65. The composition and characteristics of a useful fiber may be dictated by variables such as the intended use of the composite material and the dimensions of the incorporated microcells.

The term “microcell” as used herein and in the appended claims, is defined as a hollow body shell enclosing a microcell core. The shell may comprise glass, polymers, and other substances. Shell shapes include spheres, tubes, cubes and others. The microcell core may comprise a gas such as carbon dioxide and nitrogen, a blowing agent such as liquid isobutane, and other substances. The composition and characteristics of a useful microcell may be dictated by variables such as the intended use of the composite material and the dimensions of the intra-fiber voids.

Preferred microcells of the present invention may include expandable microcells. In one embodiment, these microcells may be incorporated into the fiber media while in an unexpanded state. The microcell core of expandable microcells may comprise a liquid or a solid blowing agent. The blowing agent of available expandable microcells may include isobutane and isopentene. Applying a triggering energy may expand the expandable microcells. Useful triggering energies may include reduction of pressure and application of heat. The shells of the expandable microcells may comprise a polymer, a co-polymer, or a polymer blend. The shell of available expandable microcells may include polyvinylidene chloride and acrylonitrile. The shells of the expandable microcells may comprise reactive functionalities that allow the expandable microcells to fuse to each other and/or the surrounding fibers upon expansion. The reactive functionalities may include polymers that have reactive sites within the polymer chain and crosslinking agents.

The more preferred microcells may be thermoplastic microspheres available from Nobel Industries of Sundsvall, Sweden under the trademark EXPANCEL. These microspheres may be obtained in a variety of sizes and forms, with expansion temperatures generally ranging from about 75 degree C. to about 198 degree C. Expansion may usually be practiced between 100 degree C. and 180 degree C. or above, depending upon a number of factors, such as dwell time.

Microcells may be incorporated into the fiber media of the present invention by any appropriate means. The means for incorporating the microcells may include centifugation, air pressure, mechanical pressure, and partial vacuum. Expandable microcells may be expanded after incorporation into the fiber media.

### EXAMPLE 1

An insulating composite material was produced according to an embodiment of the present invention as follows:

1. Fiber media composed of TRIAD (TM) nylon fiber of 6 denier was provided. The fiber media was made according to U.S. Pat No. 5,057,368 using a spinnerette with openings each consisting of three T-shaped lobes projecting therefrom, each of said lobes having a leg and a cap, the leg of each lobe intersecting at the center.

2. EXPANCEL microspheres, Product Number 091-80 purchased from Expancel Inc, 2240 Northmont parkway, Duluth, Georgia 30096, were incorporated into the fiber media by means of placing the unexpanded microspheres and the fiber media in a plastic bag and then shaking the plastic bag. The microspheres had an average unexpanded diameter of 18-24 micrometers and were capable of an average expanded diameter of 80 micrometers.

3. The fiber media with the incorporated microspheres was then heated to 125 C. in an oven, whereby the microspheres were expanded.

The composite material produced was flexible and had decreased weight and density and increased insulating properties.

As can be appreciated by those skilled in the art, the present invention provides improved composite materials and methods for their production. Also provided are improved insulating composite materials comprising microcells and fiber media, wherein microcell retention within the fiber media is increased and desirable properties of the composite material are improved. Further, the present invention provides improved methods for incorporating microcells into a fiber media without reducing resiliency, increasing weight and density, decreasing insulating properties, or increasing stiffness. Also provided are composite materials comprising fiber media and microcells, wherein microcell migration and conglomeration are reduced without the use of a barrier layer. Additionally, composite materials having decreased density and weight, increased flexibility and increased insulating properties are provided.

It should be understood, of course, that the foregoing relates to preferred embodiments of the invention and that modifications may be made without departing from the spirit and scope of the invention as set forth in the following claims.

We claim:

1. A composite material, comprising:
a fiber media, wherein said fiber media comprises at least one fiber having at least one surface projection, whereby at least one intra-fiber void is formed; and
at least one microcell in contact with said fiber media, wherein said microcell is capable of engaging said intra-fiber void.

2. A composite material as claimed in claim 1, wherein said fiber media is formed from a polymer.

3. A composite material as claimed in claim 2, wherein said polymer is selected from the group consisting of a nylon, a polyester, a polyolefin and a combination thereof.

4. A composite material as claimed in claim 2, wherein said polymer is selected from the group consisting of polyester, polypropylene, and nylon 6 with FAV (Formic Acid Viscosity) of at least about 65.

5. A composite material as claimed in claim 1, wherein said fiber media is formed from a mineral.

6. A composite material as claimed in claim 5, wherein said mineral is glass.

7. A composite material as claimed in claim 1, wherein said microcell is an expandable microsphere, whereby said expandable microsphere has an unexpanded form and an expanded form.

8. A composite material as claimed in claim 7, wherein said unexpanded form is capable of passing into and out of said intra-fiber void and wherein said expanded form is inhibited from passing into and out of said intra-fiber void.

9. A composite material as claimed in claim 1, wherein said surface projection is a continuously longitudinal lobe.

10. A composite material as claimed in claim 1, wherein said fiber has at least two surface projections, and said surface projections are continuously longitudinal lobes.

11. A composite material, comprising:
a fiber media, wherein said fiber media is formed from a polymer and said fiber media comprises at least one fiber having a shape factor of at least about 1.5 and having at least one surface projection, whereby at least one intra-fiber void is formed; and
at least one expanded microcell in contact with said fiber media, wherein said expanded microcell is capable of engaging said intra-fiber void.

12. A composite material as claimed in claim 11, wherein said shape factor is between about 1.5 and about 6.

13. A composite material as claimed in claim 11, wherein said shape factor is between about 2 and about 4.

14. A composite material as claimed in claim 11, wherein said polymer is selected from the group consisting of a nylon, a polyester, a polyolefin and a combination thereof.

15. A composite material as claimed in claim 11, wherein said polymer is selected from the group consisting of polyester, polypropylene, and nylon 6 with FAV (Formic Acid Viscosity) of at least about 65.

16. A composite material as claimed in claim 11, wherein said surface projection is a continuously longitudinal lobe.

17. A composite material, comprising:
a fiber media, wherein said fiber media is formed from a polymer selected from the group consisting of polyester, polypropylene, and nylon 6 with FAV (Formic Acid Viscosity) of at least about 65, said fiber media comprises at least one fiber having a shape factor of between about 1.5 and about 6 and having at least two continuously longitudinal lobes, whereby at least one intra-fiber void is formed; and
at least one expanded microsphere in contact with said fiber media, wherein said expanded microsphere is capable of engaging said intra-fiber void.

18. A method for producing a composite material, comprising the steps of:
providing a fiber media, said fiber media comprises at least one fiber having at least one surface projection, whereby at least one intra-fiber void is formed; and
incorporating at least one microcell into said fiber media, wherein said microcell is capable of engaging said intra-fiber void.

19. A method for producing a composite material as claimed in claim 18, wherein said microcell is an expandable microcell, and further comprising the step of applying a triggering energy capable of expanding said expandable microcell.

20. A method for producing a composite material as claimed in claim 18, wherein said fiber media is formed from a polymer.

21. A method for producing a composite material as claimed in claim 20, wherein said polymer is selected from the group consisting of a nylon, a polyester, a polyolefin and a combination thereof.

22. A method for producing a composite material as claimed in claim 20, wherein said polymer is selected from the group consisting of polyester, polypropylene, and nylon 6 with FAV (Formic Acid Viscosity) of at least about 65.

23. A method for producing a composite material as claimed in claim 18, wherein said fiber media is formed from a mineral.

24. A method for producing a composite material as claimed in claim 23, wherein said mineral is glass.

25. A method for producing a composite material, comprising the steps of:
providing a fiber media, wherein said fiber media is formed from a polymer selected from the group consisting of polyester, polypropylene, and nylon 6 with FAV (Formic Acid Viscosity) of at least about 65, said fiber media comprises at least one fiber having a shape factor of between about 2 and about 4, and having at least two continuously longitudinal lobes, whereby at least one intra-fiber void is formed;
incorporating at least one expandable microcell into said fiber media, wherein said expandable microcell is capable of engaging said intra-fiber void; and
applying a triggering energy to said expandable microcell, wherein said triggering energy is capable of expanding said expandable microcell.
